(19) United States
(12) Patent Application Publication
(10) Pub. No.: US 2017/0075869 A1
(43) Pub. Date: Mar. 16, 2017

(54) Recency Sensitive User Interface

(71) Applicant: Direct Supply, Inc., Milwaukee, WI (US)

(72) Inventor: Andrew Cook, Glendale, WI (US)

(21) Appl. No.: 15/262,728

(22) Filed: Sep. 12, 2016

Related U.S. Application Data
(60) Provisional application No. 62/216,682, filed on Sep. 10, 2015.

(51) Int. Cl. G06F 17/22; G06F 17/24; G06F 3/0482

(52) U.S. Cl. CPC G06F 17/2241; G06F 3/0482; G06F 17/247

(57) ABSTRACT

A computer-aided display for menu structures monitors use of the display elements to adjust the menu hierarchy. Promotion through the hierarchy is sensitive to an adjustable historical period. Hierarchy and information from the historical period can be captured in a single number for each menu element.

### CROSS REFERENCE TO RELATED APPLICATION

This application claims the benefit of U.S. provisional application 62/216,682 filed Sep. 10, 2016, and hereby incorporated by reference in its entirety.

### BACKGROUND OF THE INVENTION

The present invention relates to user interfaces for electronic data systems and in particular to a user interface which promotes interface categories as a function of how recently a user has interacted with that category.

Good user interface design balances comprehensive access to a wide range of information or functions with rapid access to particular information or a particular function.

One way of managing a large universe of information or functions is through a tree structure that allows the user to navigate to the functions or information by deciding among a limited number of branch levels, at each level of the tree, for successive levels. Such systems provide order to a large amount of information or function selections but suffer from the drawback that frequently used information requires substantial tree traversal time.

As an alternative, user interfaces may use a search feature that allows a user to rapidly access functions or information by searching for keywords associated with the function or information. Search features are limited by requiring the user to know the particular keyword or its approximation in order to use the search effectively.

Another approach to this problem presents a “hotlist” of frequently used information or functions (list elements) to the user based on their history of usage. This approach takes advantage of a recognition that most users concentrate on a limited set of user interface features. The hotlist provides an ordering of list elements so that elements at the “top” of the hotlist may be preferentially displayed in the order of their usage.

A simple hotlist system promotes the most recently used list elements to the top of the list while demoting the remaining list elements downward by one position. The advantage to such a system is that a single list-order number describing the ordering of the hotlist may be associated with each list element eliminating the need for storage of separate historical usage information.

### SUMMARY OF THE INVENTION

The present invention provides an improved hotlist system which, like conventional hotlists, only requires a single list-order number for each list element but which provides a more nuanced sorting of the list elements that can reflect a history of user interaction beyond the most recent interaction with the list element. Generally, list-order numbers for the list elements are increased each time the user interacts with the list element and this increase is a function of the distance between the list element and an adjacent list element (measured by differences between list-order numbers). In this way, the system provides a simple index structure for a hotlist that can be responsive to a history of recent user interactions and yet which responds rapidly to a change in user interaction patterns, allowing list elements to quickly overtake other list elements regardless of their history when particular list elements are frequently used.

Specifically, the invention provides a user interface system having one or more electronic computers including a memory, display, user interface and electronic processor. The electronic processor executes a program to display elements on the display according to a display order, the display dements invokable by the user through the user interface to control operation of the one or more electronic computers. The program controls the display order using a hotlist data structure held in memory and providing a set of list-order numbers associated with each menu element defining a display order of the display elements according the relative values of the list-order numbers of each menu element. Invocation of the display elements is monitored to change a given list-order number associated with a given invoked menu element by changing a value of the given list-order number by an amount dependent on a separation in value between the given list order number and a list order number of an adjacent menu element in the display order. After adjustment of the given list-order number, the display of the display elements is updated.

It is thus a feature of at least one embodiment of the invention to capture both historical information about menu item use and menu item order in a single term by making use of both the cardinal and ordinal qualities of each list-order term.

The given menu element may not be the highest menu element in the display order and the adjacent menu element is a next higher menu element in the display order, Alternatively, the given element may be a highest menu item in the display order and the adjacent menu element is a next lower menu element in the display order.

It is thus a feature of at least one embodiment of the invention to provide a historically sensitive ranking system that can work for each element in the list.

The amount of adjustment of each list-order number maybe a fraction of the separation in value between the given list order number and the list order number of the adjacent menu item plus a fixed increment.

It is thus a feature of at least one embodiment of the invention to provide a simple and efficient method of adjusting list-order numbers.

The method may further include the step of normalizing the list-order numbers of the hotlist data structure to at least one predetermined normalization value.

It is thus a feature of at least one embodiment of the invention to ensure computer variable range limitations are not violated.

The system may allow adding a new menu element into the display order between existing display elements by adding a corresponding list-order number to the hotlist data structure having a value between values of the list-order numbers of the existing display elements and displaying the new menu element.

It is thus a feature of at least one embodiment of the invention to provide a simple method of integrating new display elements in the hotlist.

The system may also allow deleting a menu element in the display order by removing a list order number from the hotlist data structure and no longer displaying display elements that have no list order number.

It is thus a feature of at least one embodiment of the invention to allow the deletion of menu items from the list.

The system may select from multiple hotlist data structures according to at least one of an identity of a user, an identity of a user's role, or an identity of a user's task.

It is thus a feature of at least one embodiment of the invention to allow individuals either within a group or sharing a same functional role to share a hotlist and thus benefit from the usage patterns of other individuals.

The invocation of the menu element may be the providing of focus to the menu element by the operating system.

It is thus a feature of at least one embodiment of the invention to permit capturing usage information at a high level without the need to modify multiple functions or the operating system.

The list order numbers may be floating-point number representations.

It is thus a feature of at least one embodiment of the invention to provide a simple method of encoding separation distances between hotlist items that admits to substantially arbitrary divisions and separations.

These particular objects and advantages may apply to only some embodiments falling within the claims and thus do not define the scope of the invention.

### BRIEF DESCRIPTION OF THE DRAWINGS

FIG. 1 is a block diagram of an electronic data system in an example network server system communicating with multiple terminals and including a processor executing a stored program to implement a hotlist system per the present invention;

FIG. 2 is an example display on one of the terminals showing tabbed elements ordered and populated by a hotlist system;

FIG. 3 is a flowchart of a hotlist program implementing the hotlist system of FIG. 1;

FIG. 4 is a graphic representation of the operation of the hotlist program of FIG. 1 in promoting within the hotlist a list element that has been recently used; and

FIG. 5 is a figure similar to that of FIG. 4 showing promotion of a list element that is currently at the top of the hotlist.

### DETAILED DESCRIPTION OF THE PREFERRED EMBODIMENT

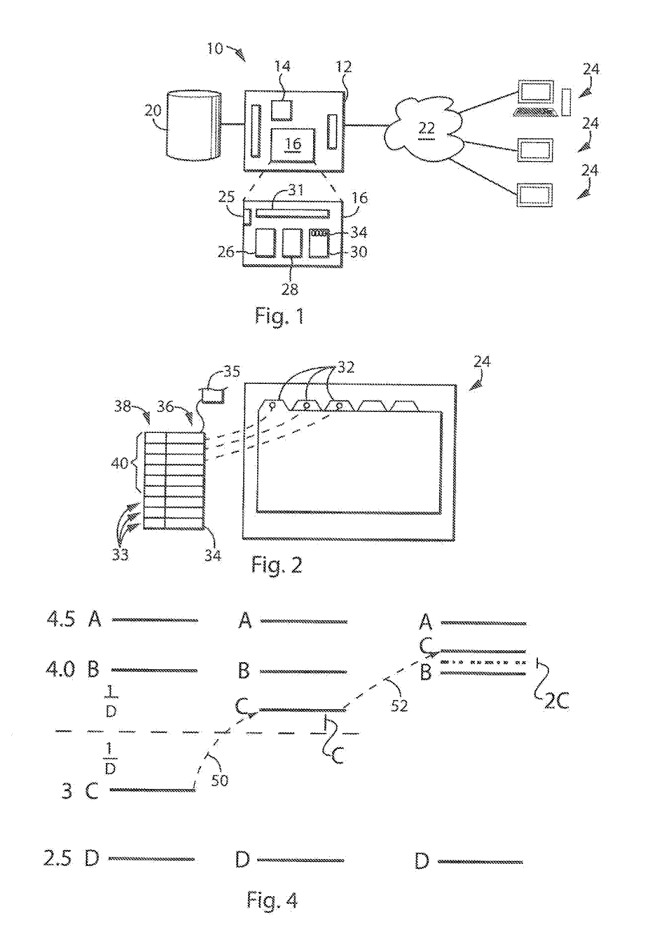

Referring now to FIG. 1, an electronic data system 10 suitable for use with the present invention may, for example, provide a server 12 providing one or more processors 14 communicating with electronic memory 16. The server 12 may also communicate with a mass storage device 20, for example, holding a database of information viewable by a user or functions executable by a user (either by client-side or server-side applications). The server 12 may also communicate with a network 22 connected with various user terminal devices 24 including, for example, desktop computers, as well as tablets and other mobile devices.

The user terminal devices 24, as will be understood in the art, may provide for display screens and user input devices such as keyboards, mice, etc., coordinated through an associated processor and memory holding an operating system and one or more application programs or the like. Typically the user terminal devices 24 will execute browser functionality to display data elements and to execute functions in coordination with server 12 as is generally understood in the art.

The memory 16 of the server 12 (in communication with the mass storage device 20) may include, for example, a database program 26 and a network server program 25 as coordinated by an operating system 31 as is generally understood in the art, for example, a Windows or Linux operating system. The electronic memory 16 may also include an adaptive menu program 30 of the present invention as will be described below providing multiple hotlists 34 associated with individuals as will be discussed below. The adaptive menu program 30 will operate to invoke various functions 28, for example, for the display or manipulation of data in the storage device 20.

Referring now to also to FIG. 2, the adaptive menu program 30 may control the appearance of the displays of the terminal devices 24 providing the user with information or functions. In one nonlimiting example, the display may provide information or functions arranged in a set of ordered tabs 32 typically representing a subset of a larger set of information or functions. As will be understood in the art, individual information or function elements may be selected by selecting individual tabs 32 that typically include labels to guide the user for that purpose. Such selection may, for example, be provided by touching the tab 32 using a touchscreen or clicking on the tab 32 using a mouse or the like to allow the user to review the information or interact with the function or information. For example, tabs 32 may provide for functions or information related to allowing the user to: (1) browse a catalog, (2) make a quick order, (3) review the user's order history; (4) review messages to the user; and (5) review approvals to make orders.

The tabs 32 will be logically associated with a hotlist 34 including a set of logical rows of list elements 33, each row related to one tab 32, and each row having different logical columns related to different categories of information or type of function. Each list element 33, for example, may link tab information 36, for example, pointing to particular information or a program executable when the tab 32 has focus, to a list-order number 38 used to determine the order of the list elements 33 and hence the tabs 32 as displayed on the terminal device 24. The list-order numbers 38 also define a subset of tabs 32 that will be displayed, the subset normally being the “top” tabs 32 according to a sorting of the hotlist list-order numbers 38. In this regard, it will be appreciated that a wide variety of different displays can be associated with a hotlist 34 other than one incorporating tabs 32 including the pulldown menu displays, bulleted lists of hotlinks, tree displays, text lists and the like. Henceforth these different application elements (tabs 32, pulldown menu elements, bulleted lists, etc.) will be termed collectively display elements 32.

As will now be discussed, the list-order numbers 38 of the hotlist 34 are adjusted according to recent interactions by the user with the associated functions or information for each list element 33, for example, measured by how often the menu item is invoked or “clicked”. Changing the list-order numbers 38 changes the display order of the display elements 32 in the hotlist 34 and hence defines which display elements 32 are displayed and the order of the display of the display elements 32.

Generally, a different hotlist 34 may be associated with each different user so that the hotlist provides a personalized user experience. This may be done, for example, by providing a different hotlist linked to a user identification 35 for each user based on the user's login information. Similarly, hotlist 34 may be associated with departments or functions within a business so as to contain a historical “memory” of transactions within that department or business that may be shared by all users. In this case the user identification 35 may be a department embracing a variety of login credentials. Likewise a hotlist 34 may be associated with particular activities by a user for which all of the elements of the hotlist 34 may be relevant but may have different importance. Multidimensional hotlist 34 may relate to particular combinations of individuals tasks or departments coded in the user identification 35

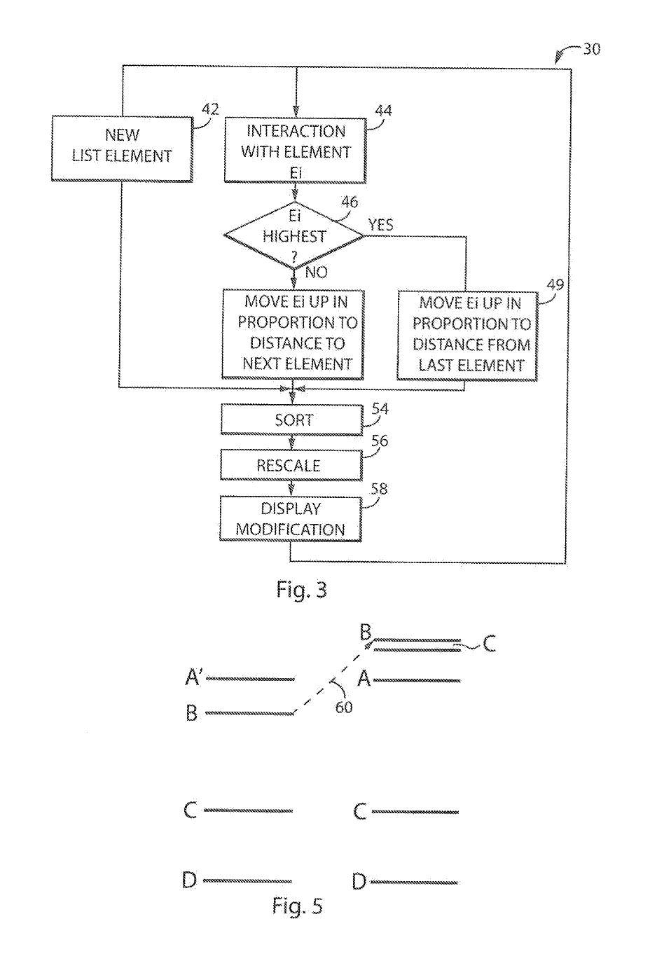

Referring now to FIGS. 2 and 3, the list-order numbers 38 of the hotlist 34 may be arbitrarily initialized to a set of unique numbers (for example, sequential integers held in floating-point variables) by the program 30 before any user interaction. This ordering may reflect a before-the-fact expectation of frequency of use of each menu element 32. In a preferred embodiment, these initialized list-order numbers 38 may then be normalized to an average value, such as one, by dividing each number by the current mean (average). The highest list element 33 in the hotlist 34 will have the highest list-order number 38.

At any time after this initialization, as indicated by process block 42, a new list element 33 may be entered into the hotlist 34 by assigning it a list-order number 38 within the range of list-order numbers. When the new list element 33 is intended to be inserted between two other list elements 33, the assigned list-order number 38 of the new list element 33 will be numerically between the list-order numbers 38 of the flanking list elements 33. Thus, for example, if element C is to be placed between element A, the latter having an list-order number 38 of 1.3 and element B, the latter having an list-order number of 1.4, element C may be given an list-order number of 1.35. One method of selecting this list-order number is simply to average the list-order numbers of the flanking display elements 32.

If the new list element 33 is to be the top list element, it may be given a list-order number 38 larger than any other list element 33. Thus, for example, if element C is to be placed at the top of the hotlist 34 and the currently highest valued list-order number is 1.4, element C may be given a list-order number of 2.4. One method of selecting such a list-order number is to add one to the highest value of the existing list-order numbers.

A list element 33 may be removed at any time without adjustment of the list-order numbers 38 of the remaining list elements 33. The list element 33 may be removed or its list order-number removed (i.e. set to a null value) to similar effect

It will be appreciated that this change in the hotlist 34 will be accompanied by corresponding graphical changes in the display of the display elements 32 to insert the menu element 32 in a particular location between existing display elements 32, or to place a new menu element 32 on the display (typically removing a lower ranked menu element) or to remove a menu element 32 promoting a lower ranked menu element 32 and those elements below that menu element 32.

Once the elements of the hotlist 34 have been assembled, their ordering may be changed upon interaction by the user with a given menu element and corresponding hotlist element 33 (designated Eᵢ in FIG. 3) having index Ii as indicated by process block 44 where i is the relative order of list-order numbers 38 of the hotlist 34 such as will generally be in accordance with relative values of the list-order numbers 38. List-order number i is zero for the uppermost list element 33 having the highest list-order number 38.

Per process block 44, interaction can be flexibly defined, for example, to mean a viewing of particular data elements associated with the list element 33 or invoking a function associated with the element 33. In one example, any menu element 32 that has “focus” as defined by the operating system may be counted as an interaction at the time of receiving focus. Note that focus may be distinguished from the visibility of the menu element 32 in that a visible menu element 32 may still not have focus attained by clicking on the tab with the mouse or the like.

At decision block 46, a determination is made as to whether element 33 associated with Iᵢ (being the subject of interaction) is the uppermost element (e.g., having a list-order number 38 designated I₀). If not, the program 30 proceeds to process block 48 and an updated list-order number Iᵢ is calculated computing the difference between Iᵢ of the current element and the list-order number of the next highest element Iᵢ₋₁, adding to that difference a constant fractional value c between zero and one (in this example 0.1) and dividing that entire quantity by a step value D greater than one (in this example 2) per the following equation (1):

$${I}_{i} = {I}_{i} + \frac{{I}_{i - 1} - {I}_{i} + c}{D} . \qquad ( 1 )$$

Referring now to FIG. 4, consider the list element 33 designated C and being the subject of recent interaction and having list-order number 38 of Iᵢ of 4. Assume that the next highest list element 33 designated B has a list-order number 38 of 3. The height of these list elements S and C as depicted in FIG. 4 will be generally representative of the relative size of its list-order number 38 with respect to other list elements 33.

The modification of equation (1) will increase the value of Iᵢ for list element C by one half the distance between element C and the next highest element B plus a small increment c as indicated by arrow 50. Specifically, the list-order number 38 for C will increase from 3 to 3.55 per the following calculation:

$$3.35 = 3 + \frac{4 - 3 + 0.1}{2} .$$

In this way, in the next interaction with C, the height of element C (and hence its list-order number 38) will be such as to have taken over the position of second place list element 33 (B) per arrow 52 upon a succeeding sorting of the list elements 33 at process block 54 shown in FIG. 3.

The parameter D roughly determines how many interactions with a given list element 33 are necessary to bring a given list element above the next higher list element. This number of necessary interactions is largely independent of the separation between the given list element 33 and the next higher list element 33 thus preventing a given list element from being submerged for a long period of time beneath a higher list element that was previously popular over a long period of time but is no longer popular.

The increment c prevents ties between successive list elements 33 as they are promoted (e.g., being the ease where both have the same list-order number 38) and prevents the step distance of rising element C (being determined with respect to its distance from element B) from carrying over into the transition of rising element C with respect to element A.

it will be appreciated that the system is sensitive to the history of interactions between the user and the user interface beyond the most immediate interaction (the history being proportional to D) but does not require separate history data to be stored because this history is implicitly stored within the list-order numbers 38.

At process block 56, after the sort block of 54, each of the list-order numbers 38 for each list element may be re-normalized by dividing them by the mean value although it will be recognized that this process need not occur upon each change of an element because the sorting will remain unaffected by this step which is intended simply to prevent long-term overflow.

At process block 58, the display on the terminal devices 24 as provided by the server 12 may be changed according to the new sorting of the hotlist 34, for example, as shown in FIG. 2 by providing a new set of display elements 32 or changing the ordering of the display elements 32, for example, so that the most frequently used tab is farthest to the right (as shown in the figure) and initially is visible albeit without “focus”.

Referring now to FIGS. 3 and 5, if at decision block 46 the given list element 33 having interaction is the uppermost list element having an list-order number I₀, then at process block 49 the amount of upward movement (e.g., the incrementing of I₀ upon each interaction) is determined with respect to the element proceeding element I₀ (e.g., I₁) by computing the difference between the list-order number I₀ and I₁, adding to that difference the constant fractional value c and dividing that entire quantity by the step value D as before and per the following equation (2):

$${I}_{0} = {I}_{0} + \frac{{I}_{0} - {I}_{i - 1} + c}{D} . \qquad ( 2 )$$

The result is that list element 33 associated with list-order number I₀ continues to rise as indicated by arrow 60 albeit not in a way that prevents lower elements 33 from quickly catching up to it.

The program 30 then proceeds through process blocks 54, 56, and 58 as discussed above before looping back to either of process blocks 42 or 44 depending on the next interaction.

While the example shows the list-order numbers as floating-point fractional numbers, it will be appreciated that they may also be integers, for example, normalized to a large number, for example, 10,000, to ensure adequate space for introduction of new list elements. Calculations described above may then be performed with integer arithmetic.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side” describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to any computing device can be understood to include one or more computing devices that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A user interface system comprising one or more electronic computers including a memory, display, user interface and electronic processor for executing a program stored in a non-transient medium to:
(a) provide a displaying of display elements on the display according to a display order, the display elements invokable by the user through the user interface to control operation of the one or more electronic computers;
(b) control the display order using a hotlist data structure held in memory and providing a set of list-order numbers associated with each menu element defining a display order of the menu element according relative values of the list-order numbers of each menu element;
(c) monitor invocation of the display elements to change a given list-order number associated with a given invoked menu element by changing a value of the given list-order number by an amount dependent on a separation in value between the given list order number and a list order number of an adjacent menu element in the display order; and
(d) update a displaying of the display elements on the display according to a new display order produced after step (c).

2. The user interface system of claim 1 wherein the given menu element is not a highest menu element in the display order and the adjacent menu element is a next higher menu element in the display order.

3. The user interface system of claim 1 wherein the given element is a highest menu item in the display order and the adjacent menu element is a next lower menu element in the display order.

4. The user interface system of claim 1 wherein the amount dependent on a separation in value between the given list order number and a list order number of an adjacent menu element in the display order is a fraction of the separation in value between the given list order number and the list order number of the adjacent menu item plus a fixed increment.

5. The user interface system of claim 4 further including the step of (e) after step (c) normalizing the list-order numbers of the hotlist data structure to at least one predetermined normalization value.

6. The user interface system of claim 5 further including the step of adding a new menu element into the display order between existing display elements by adding a corresponding list-order number to the hotlist data structure having a value between values of the list-order numbers of the existing display elements and re-executing step (d) to display the new menu element.

7. The user interface system of claim 6 further including the step of deleting a menu element in the display order by removing a list order number from the hotlist data structure and wherein at step (d) a corresponding menu element is no longer displayed.

8. The user interface system of claim 7 wherein step (b) further selects from multiple hotlist data structures according to at least one of an identity of a user, an identity of a user's role, or an identity of a user's task.

9. The user interface system of claim 1 wherein invocation of the menu element provides focus to the menu element by an operating system.

10. The user interface system of claim 1 wherein the list order numbers are floating-point number representations.

11. A method of presenting data in a list form using a user interface system comprising one or more electronic computers including a memory, display, user interface and electronic processor for executing a program stored in a non-transient medium to:
provide a displaying of display elements on the display according to a display order, the display elements invokable by the user through the user interface to control operation of the one or more electronic computers;
control the display order using a hotlist data structure held in memory and providing a set of list-order numbers associated with each menu element defining a display order of the menu element according relative values of the list-order numbers of each menu element;
monitor invocation of the display elements to change a given list-order number associated with a given invoked menu element by changing a value of the given list-order number by an amount dependent on a separation in value between the given list order number and a list order number of an adjacent menu element in the display order; and
update a displaying of the display elements on the display according to a new display order produced after step (c); the method comprising:
(a) monitoring invocation of the display elements to change a given list-order number associated with a given invoked menu element by changing a value of the given list-order number by an amount dependent on a separation in value between the given list order number and a list order number of an adjacent menu element in the display order; and
(b) updating a displaying of the display elements on the display according to a new display order produced after step (a).
